(19) United States
(12) Patent Application Publication
(10) Pub. No.: US 2006/0282396 A1
(43) Pub. Date: Dec. 14, 2006

(54) Multi-jurisdictional electronic-commerce legal products, methods of production and methods of conducting business therewith

(75) Inventors: Derek A. Newman, Seattle, WA (US); Brian R. Cartmell, Seattle, WA (US); Rod Collen, Seattle, WA (US)

Correspondence Address: John P. luther;Newman & Newman, LLP, Suite 610, 505 5th Avenue South, Seattle, WA, 98104, US

(73) Assignee: Civil Foundation, LLC

(21) Appl. No.: 11/150,446

(22) Filed: Jun. 9, 2005

(51) Int. Cl. G06Q 99/00; H04L 9/00; H04K 1/00

(52) U.S. Cl. 705/80; 705/1

(57) ABSTRACT

The present invention provides novel e-commerce methods for the user-fabrication of jurisdiction specific documents of a legal nature and various methods of conducting business comprising such methods, fabricated documents and a system encompassing such methods and products.

### COPYRIGHT NOTICE

Copyright 2005 Newman & Newman, Attorneys at Law, LLP. All rights reserved. A portion of the disclosure of this patent application/patent disclosure contains material which is subject to copyright protection. The copyright owner has no objection to the facsimile reproduction by anyone of this document or patent which issues therefrom as it appears in the United States patent and Trademark Office file and records.

### FIELD OF THE INVENTION

The present invention relates to E-commerce methods and products and the system therefor, and more particularly to documents and materials prepared and designed for use in specific jurisdictions as desired, and which are offered and disseminated by way of E-commerce, and further to an array of methods of conducting business employing such E-commerce methods and products.

### BACKGROUND OF THE INVENTION

The ever increasing popularity of the Internet continues to provide an expanded array of opportunities for individuals to purchase electronic commerce (“e-commerce”) items over a global network with access from any of a number of terminals, such as a personal computer or laptop, or a mobile telephone or other wireless phone devices enabled with Short Message Service (“SMS”), Multimedia Messaging (“MMS”) or Enhanced Messaging Service (“EMS”) protocol, or a Personal Digital Assistant (“PDA”) and the like which may access the mobile Internet by way of a WAP (“Wireless Applications Protocol”) site. Such devices are commonly used to purchase from online merchants electronic commerce methods and products which do not need to be physically delivered to a purchaser user, and which in some instances may be simply download from an Internet web site. Some examples include electronic ticket confirmation, software products and other executables. In other instances, there may be provided electronic-commerce products in the form of an electronic receipt or indication of purchase of a physical object, such as a product purchased over the Internet for later delivery or from e-commerce auctions.

In one example, International Patent Applications No.PCT/EP01/06435 discusses the purchase of e-commerce objects associated with an interactive address link pointing to specific web sites or an additional e-commerce object. The specific web site or additional e-commerce web site provides information relating to the e-commerce object. After receipt of the e-commerce object by purchaser, the web site may then be accessed by interfacing with an address link within the e-commerce object to obtain information stored on the web site.

An interactive e-commerce product is also discussed in U.S Patent Application Publication No. 20020140735 in which a website performs in the manner of a paper publication such that it may be read like a book or a magazine in which each screen display represents a double page spread which a user may turn like book pages. The interactive system may also use different features in the manner of a combination of text, sound, motion, images or video in a multimedia format.

Another example includes U.S. Patent Application publication No. 2003212582 which discloses a network-based method and system which automates the process of evaluating a consumer's legal claim, and based on an analysis of the merits of the claim automates electronic acceptance of the consumer's legal claim or automates electronic rejection of the claim, as based on E-SIGN Electronic Signatures in Global and National Commerce Act which allows for such a business model. In use, this system and method collects claim information from consumers who have potential product liability claims and automatically scores and automatically evaluates and scores those claims according to factual and medical indicators established for such a product claim, and once scored the system decides to either reject the consumer for legal representation or attempt to retain the consumer. Law firms may use this system to send electronic mail notifying a consumer of a decision not to offer representation or a decision to offer representation with an electronic contract generated and forwarded for the consumer to digitally sign online to retain the services of the firm.

In U.S. Patent Application Publication No. 20030084004 there is disclosed the automated assembly of an electronic contract by way of contracts generated by a word processor or those scanned into a system and then modified by way of a contract encoder which uses an encoding system to encode contract parameters according descriptions published by a modeller. The contract encoder links descriptors for a formal contract to structural textual contract descriptors by way of provided associations, and with the formal contract model defining allowable values that can be assigned to each descriptor. During the encoding of a specific contract descriptors are assigned appropriate values defined by a contract drafting tool. This system is somewhat disadvantageous as a user must still search the Internet or other sources for the most appropriate contract format, such as by way of a search engine before contract drafting. The automated contract drafter is also not designed to comport to local laws, rules or regulations.

Still other examples include an interactive Internet-based insurance marketing method and system for the purchase of insurance products as disclosed in U.S. Patent Application Publication No. 2002046063; an Internet-based method and system for the purchase of products from Internet vendors as disclosed in U.S. Patent Application Publication No. 2001027427; Internet-based contract labor agreements with authorized electronic payment for services rendered as disclosed in U.S. Patent Application Publication No. 2002161619; an Internet-based method for entering and/or cancelling service contracts such as disclosed in European Patent Application No. 1187047; and an Internet-based method and system for investing corporate working capital as disclosed in U.S Patent Application Publication No. 2005119958.

As may be ascertained, there exist yet many opportunities for innovative methods and systems to fully exploit the Internet venue in offering and vending services and products, and especially those of an interactive nature where products with attendant services may be purchased and/or actually constructed and then stored by way of a web site for later retrieval and use. To this end there has not been provided an automated way of composing contracts, agreements, wills and other legal documents by way of e-commerce, such as by a user in virtually any geographic location being provided a menu as a starting point for document construction, and in which such documents of a legal nature may be tailored to be jurisdictional specific or for use in specified factual contexts.

### SUMMARY OF THE INVENTION

In accordance with that above, the present invention fulfills a longfelt need by providing an Internet-based e-commerce method and system for choosing templates and self-constructing contracts, agreements and other documents of a legal nature online which are jurisdictional specific and optionally periodically updated for changes in the applicable law, and which may further be stored in a central depositary for safe keeping and retrieval on demand, and for reformatting and amending as based upon changing facts, laws, statues, rules, regulations and other intrinsic and extrinsic factors.

The invention is more fully explained and understood with reference to the following Detailed Discussion of Preferred Embodiments with accompanying drawings.

### BRIEF DESCRIPTION OF THE DRAWINGS

FIG. 1 illustrates a document prepared by a user in accordance with the invention which is automatically fabricated as jurisdiction specific as desired.

### DETAILED DISCUSSION OF PREFERRED EMBODIMENTS

All patent references, published patent applications and literature references referred to or cited herein are expressly incorporated by reference to the same extent as if each were specifically and individually incorporated by reference. Any inconsistency between these publications and the present disclosure is intended to and shall be resolved in favor of the present disclosure.

In the following discussion many specific details are provided to set forth a thorough understanding of the present invention. It will be obvious, however, to those skilled in the art that the present invention may be practiced without specific details, and in some instances of this discussion, with reference to the drawing, known elements have not been illustrated in order not to obscure the present invention in unnecessary detail. Such details concerning computer networking, software programming, telecommunications and the like have not been specifically illustrated as such are not considered necessary to obtain a complete understanding of the core present invention, but are considered present nevertheless as such are considered to be within the skills of persons of ordinary skill in the art.

Additionally, the processing depicted in the drawings and described below is generally depicted as hierarchical in structure for readability and understandability. Various other methodologies, such as object oriented techniques, are contemplated for the physical embodiments of the invention such as to maximize the use of existing programming technique. One of ordinary skill in the art will appreciate that the techniques described herein may be embodied in many different forms.

Furthermore, for illustrative purposes only, the following discussion illustrates and discusses the present invention in reference to various embodiments which may, perhaps, be best utilized subject to the desires and subjective preferences of various users. One of ordinary skill in the art will, however, appreciate that the present invention may be utilized to produce by way of e-commerce any sort of agreement, contract, memorandum of understanding, letter of intent, will and the like or any document of a legal nature or with legal ramifications, any of which may be tailored to specific language and recitations representative of the legalities of specific jurisdictions as desired.

Having thus prefaced this discussion, the present invention provides an e-commerce method, product and system for users to efficiently and effectively construct and/or prepare any type of document of a legal nature or with legal ramifications, such as contracts, agreements, wills and the like employing preformatted skeletal drafts of such documents tailored to encompass language tailored to the legalities, and preferably local custom and usage, of specific jurisdictions, such as to requirements of terms and the like in accordance with state law, rules and regulations as applicable. As known, for example, in the case of contracts and various agreements such usually need to be prepared with respect to an established context, oftentimes employing an existing contract history with attendant background information. Their preparation may also oftentimes become an involved laborious affair, complicated in nature, and usually only competently handled by a legal professional at not insubstantial cost. The present invention, by way of Internet and e-commerce capability, eliminates or least substantially reduces such complexities in contract and agreement preparation, and that of other legal documents, by interactively enabling a user to select a starting construct or template document from a provided menu and through an electronic interview means to use same to fabricate a finished document of a legal nature reflecting or dictated by the parties' intent, such as contractual intent, and as dictated by surrounding facts and circumstances. The thus fabricated document is preferably automatically tailored to reflect language, where appropriate in the body of the document, through the interactive interview means which is jurisdiction-specific to state law, local laws, rules and regulations, or even to that of any jurisdiction or geographic location foreign to the United States and its territories. By the term “parties” as used herein it is meant to refer to any person or persons, whether direct contracting parties or ancillary parties, such as third party beneficiaries, or any business entity which may be involved in any way with the subject matter of a document. A document may be one that requires the execution of only one party, such as an assignment or power of attorney, or may involve several parties. However, the term “parties” will oftentimes be defined with precision within a specific document.

In one preferred exemplified embodiment, there is provided an interactive e-commerce system useable on an Internet accessible means, or by way of a wireless device, such as an SMS, EMS or MMS enabled phone, through, for instance, a WAP site, for the automated drafting of a contract or agreement, or other document of a legal nature. The system comprises an electronic Internet accessible image repository for storing an electronic file of an image of a template or construct of a desired document type, such as, for instance, a contract in the nature of a cohabitation agreement, or some type of living or partnering agreement or other document of a legal nature. The type of agreement, or document for that matter, is not critical to the practice of this invention which contemplates the e-commerce assisted self-fabrication of virtually any jurisdiction-specific document. For ease of understanding a document which is contractual in nature is employed in this illustration.

Further, the system includes an interactive question and user response means of which a user is confronted with and prompted to respond to determine and display an appropriate incomplete construct or template reflecting jurisdiction specific language as appropriate, and optionally, a modeller means for storing descriptions for a formal contract model, or for storing a preformatted or partially constructed model (a “construct” or “template”), and a tool means for enabling the contract or agreement to be formatted and displayed as desired, or optionally according to the preformatted model. The modeller means may make layout models for documents, such as a contract or agreement, available through the repository and a tool which enables a document to be formatted according to the layout model displayed, all of which are made available to users of the e-commerce repository.

In other preferred embodiments, there are contemplated Internet web site accessible constructs or templates of documents available for purchase which may be modified as to contemplated parameters, terms and the like in accordance with the results of an interactive question and response means. In accordance with a user-completed interactive question and response means, a document formatter means may be employed to display a jurisdiction specific layout model and tools to create a structured textual document, such a contract, on the basis of the contract image. E-commerce contract drafting techniques and examples of suitable methodologies are discussed, for example, in U.S. Patent Application Publication No. 20030084004.

Many agreements found useful by people during recent times are those which reflect conditions, facts and circumstances outside of a traditional marital status. To this end, some contemplated examples of constructs or templates of documents which may be selected or otherwise made available to a user in accordance with this invention include, without limitation, a partnering agreement; a co-habitation or living together agreement; a living will health care directive which set out how one may want to be cared for if terminally ill or incapacitated in some way, or if permanently unconscious and unable to communicate will instruct one's desires how far one's life should be prolonged; parenting agreements which may set out the parties' intentions of parenting a child together; a power of attorney; wills and codicils, a living trust to retain control of one's property while alive; joint debt agreements; agreements reflecting financial decisions; agreements with terms as to joint purchases; joint property ownership agreements; appointment of a successor trustee; appointment of a successor executor and personal representative; appointment of a successor health care agent; and a revocation of a power of attorney. These examples are in no way intended to be limiting of this invention and merely illustrate some of the many different types of jurisdiction specific documents which may be fabricated in accordance with the invention, and also illustrate the invention's advantageous flexibility. Indeed, as another illustration a contract for the sale of goods tailored to comport to a state's specific form of Uniform Commercial Code provisions is also contemplated for use herein.

Further in accordance with other preferred embodiments of this invention, once a document construct is selected from an Internet web site provided menu, or perhaps an MMS message, preferably a version specific to a user-indicated jurisdiction such as a state or based, for example, on a zip code or an address, a user may be prompted to answer one or more of a series of questions pertaining to the specific document. For example, in the case of a living together agreement, a questionnaire may be presented as follows:

### EXAMPLE 1

Document Questionnaire

You must first answer the following questions before you can download this document. Questions which require an answer are marked with a * (red asterisks)

| | | | |
|---|---|---|---|
| In addition to living together, do you also plan | * | yes | no |
| to maintain separate residences? | | | |
| Have the two of you obtained a marriage license | * | yes | no |
| and become married to each other? | | | |
| Have the two of you registered as Domestic | * | yes | no |
| Partners? | | | |
| Have the two of you entered into a Civil union? | * | yes | no |

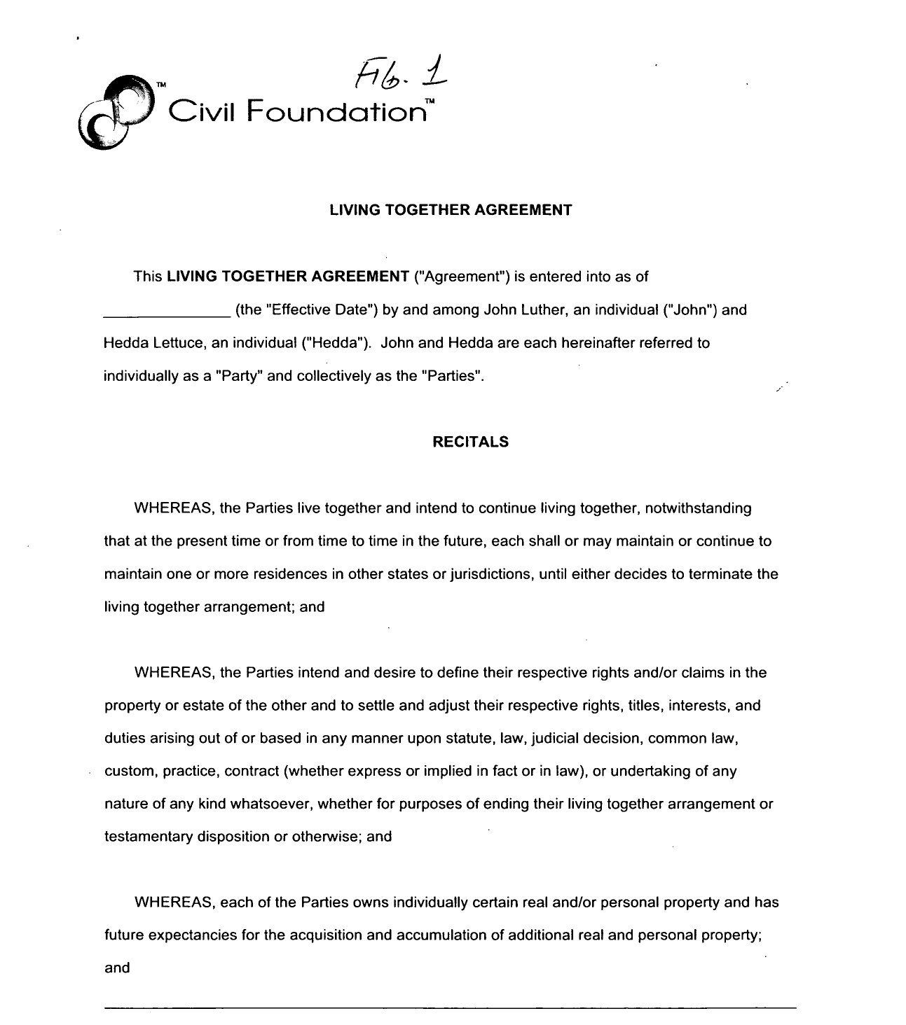

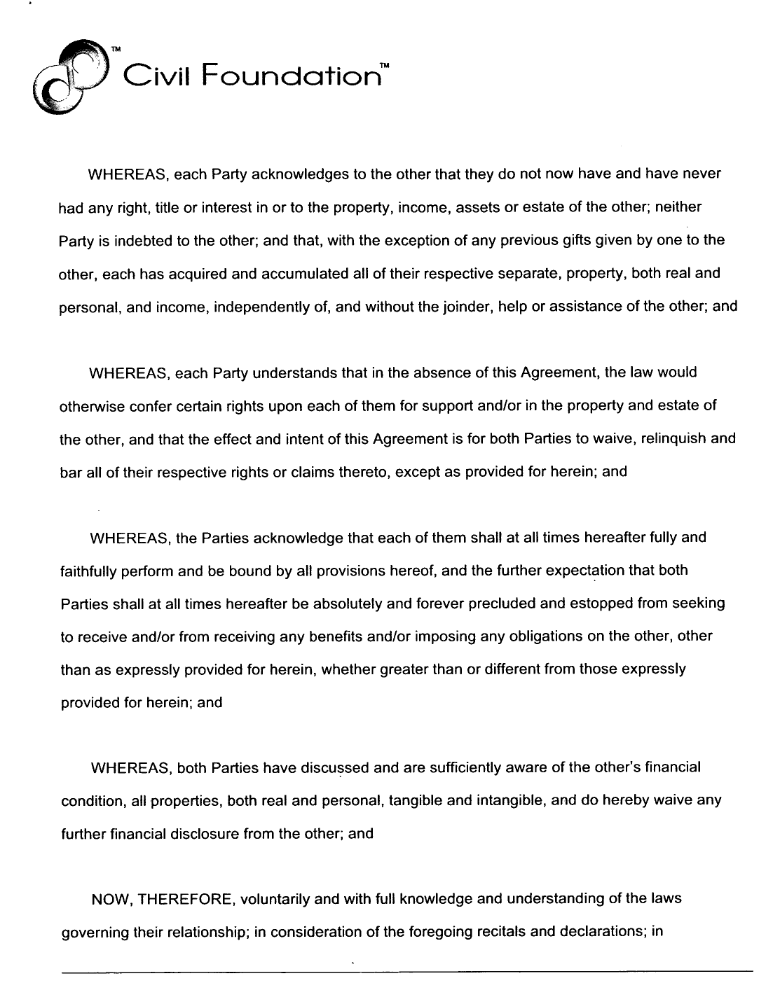

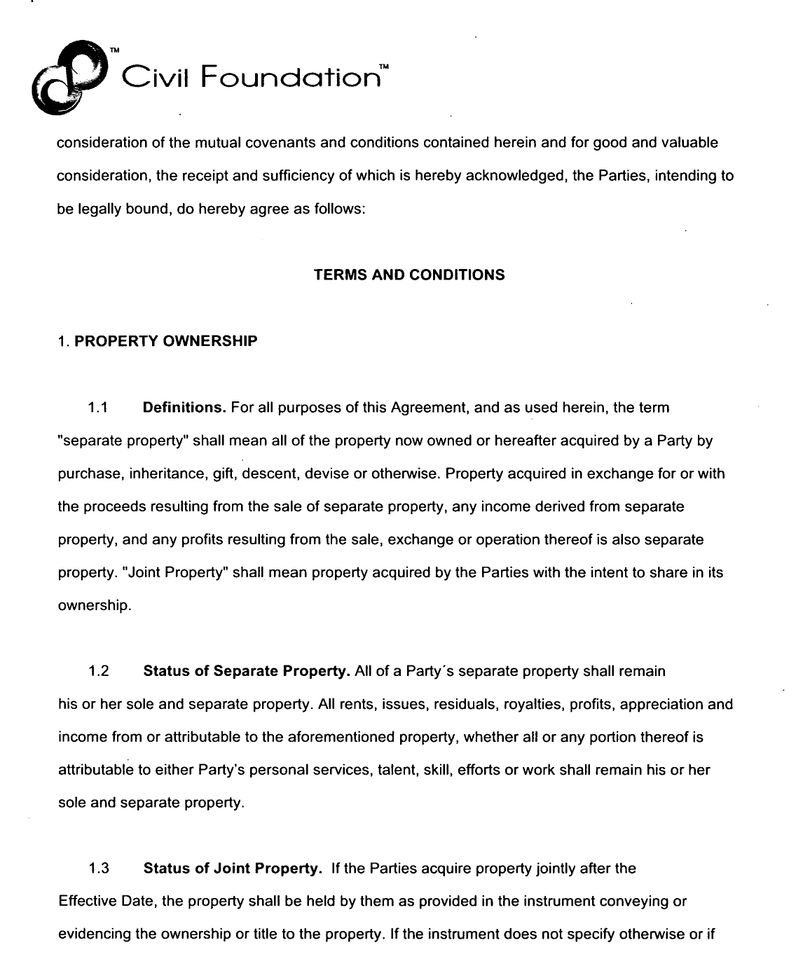

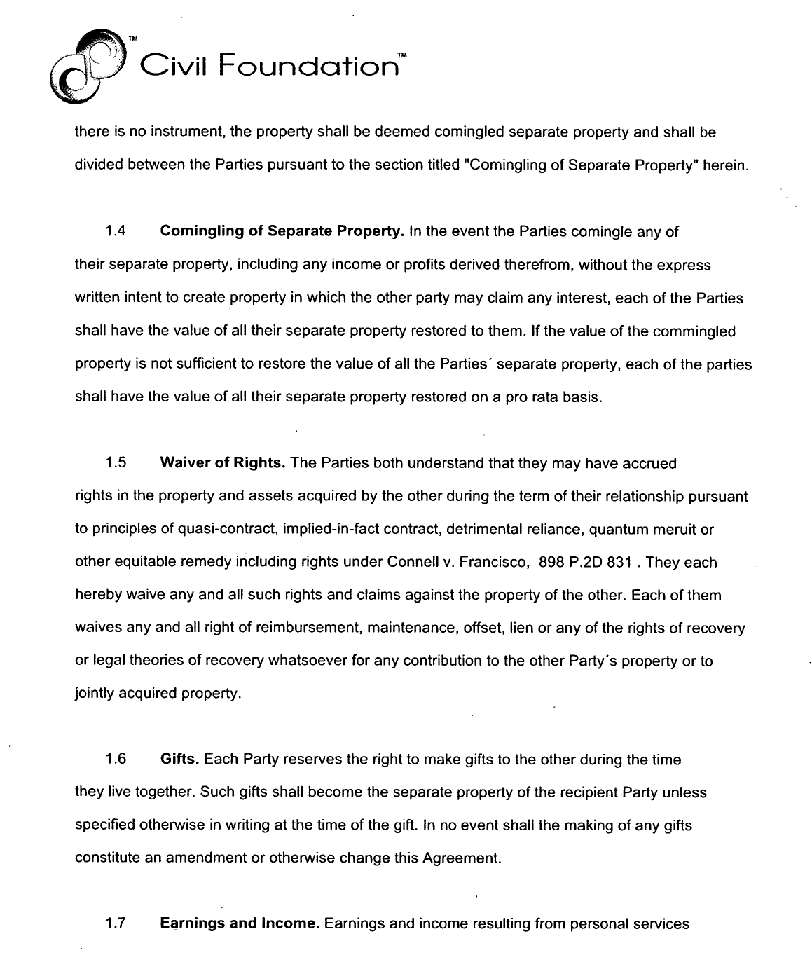

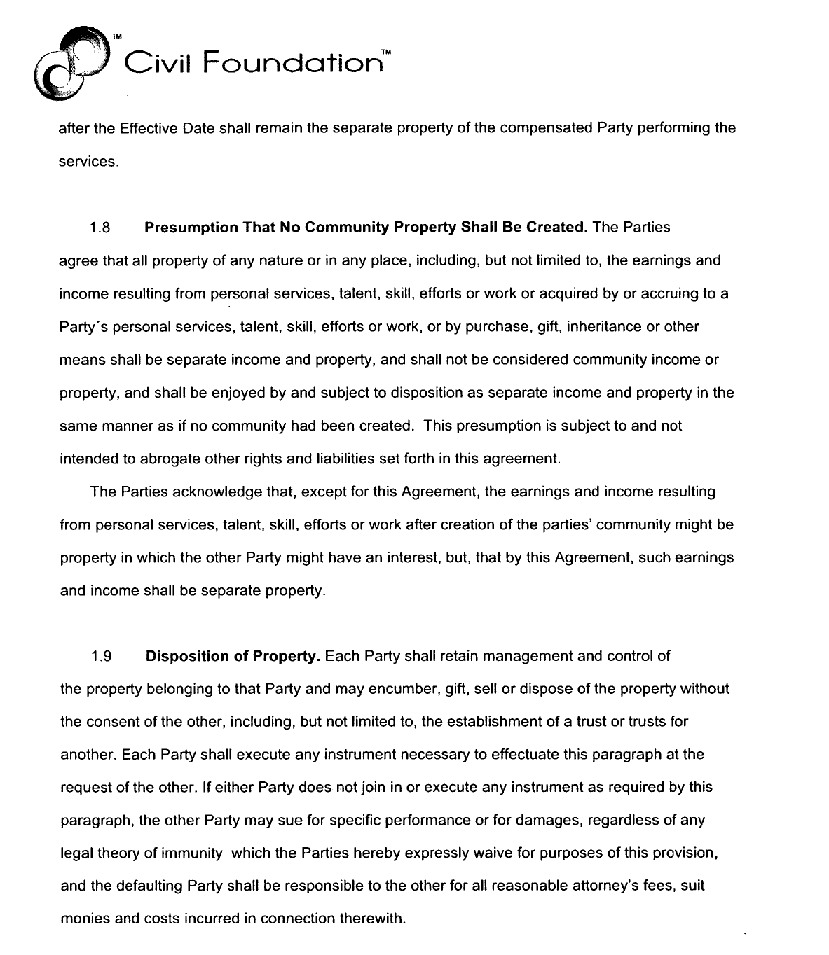

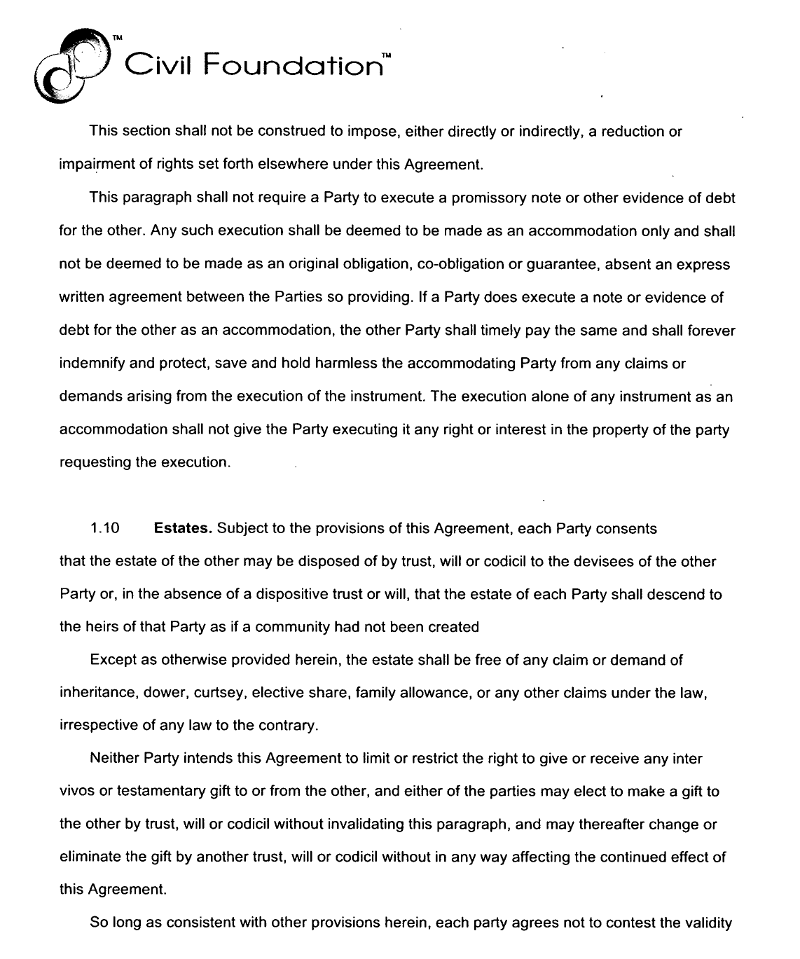

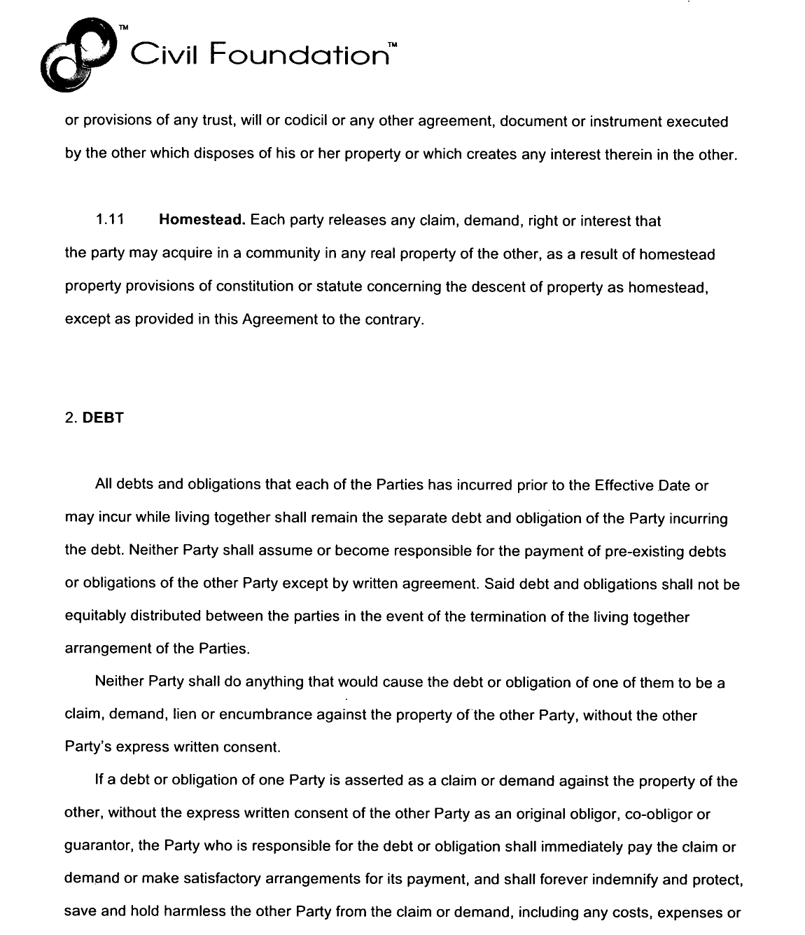

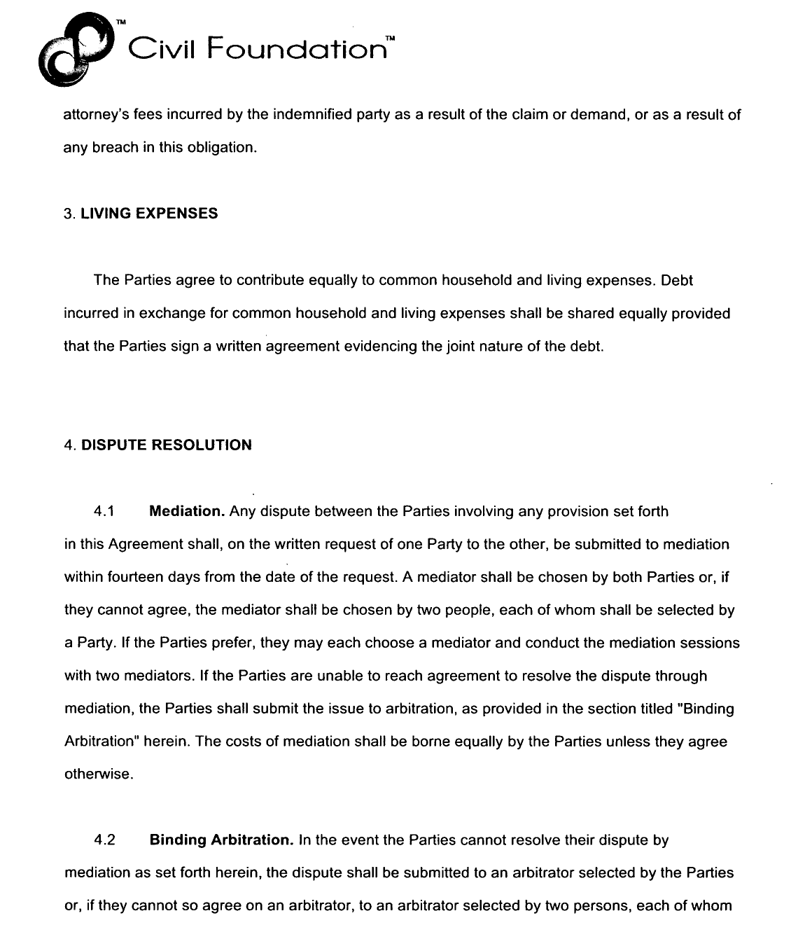

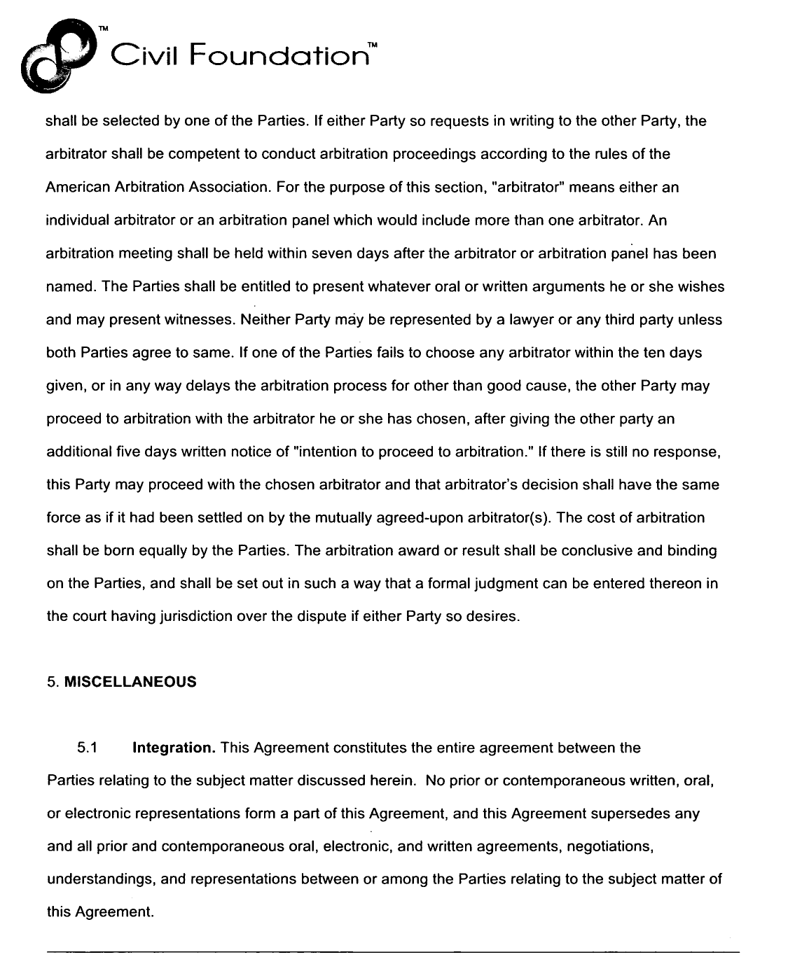

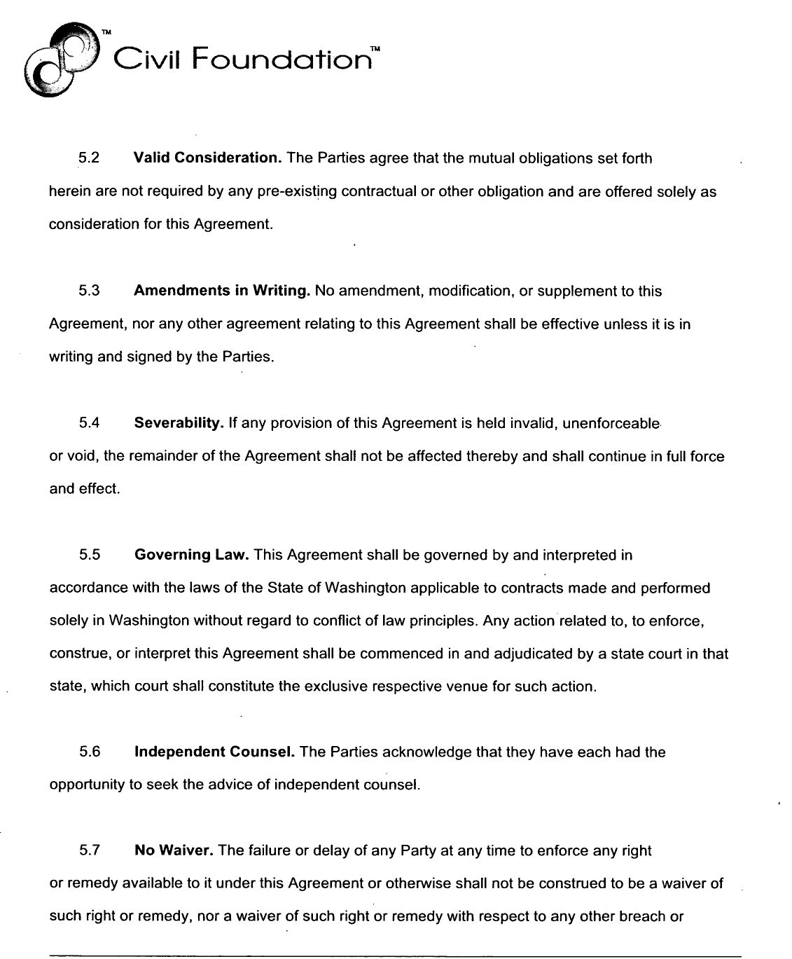

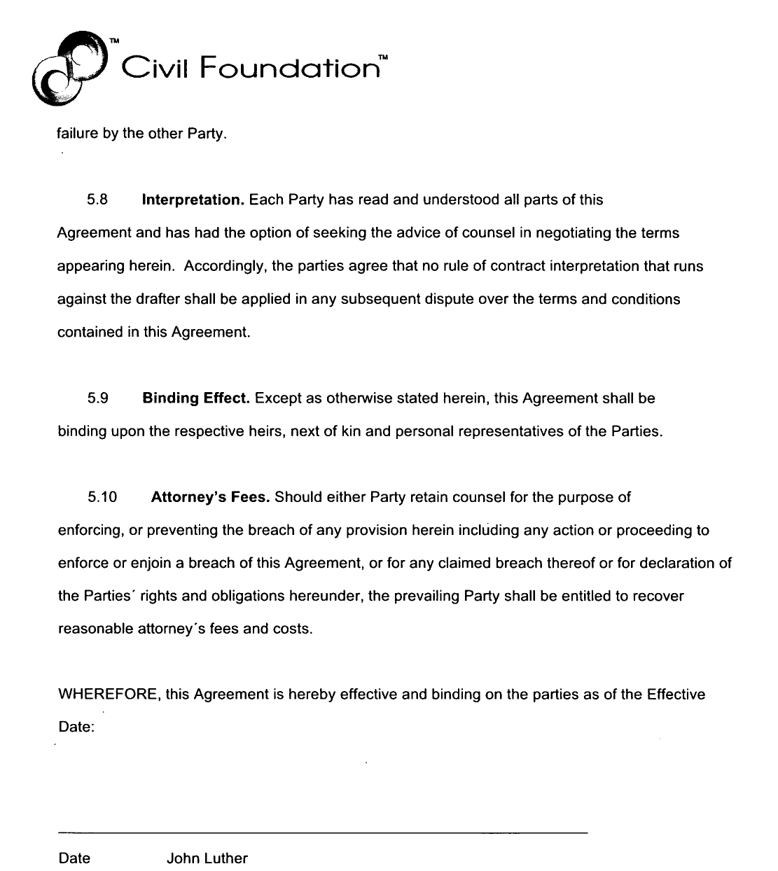

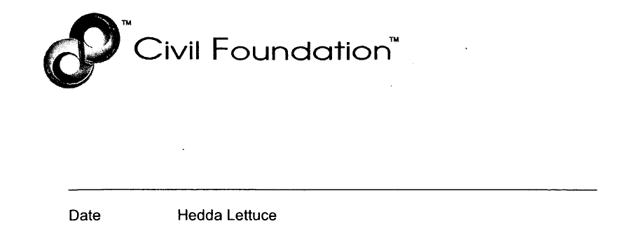

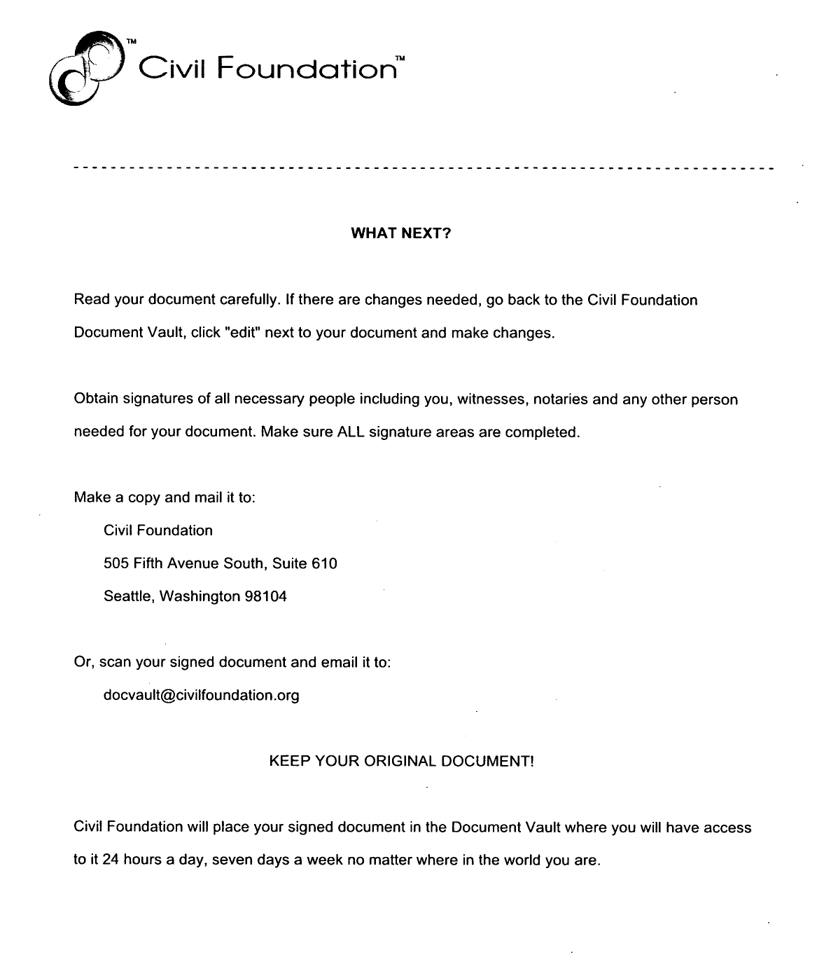

Upon completion of the questionnaire, a document reflecting appropriate language in response to the user's answers may then be downloaded for the automatic fabrication of a custom made document with parameters tailored to the facts and circumstances, and intent, of the user(s), and which is also jurisdiction specific. An example of a user-created, jurisdiction specific document is shown in FIG. 1.

The present invention also optionally provides an annotation feature accessible by a user contemplating a particular document which displays a summary of the local law applicable to the nature of the document and the facts and circumstances of the user, and which is updated as required to reflect changes in the law. This feature, which may be made available, for example, in a drop down menu when a user is contemplating a document specific to a certain jurisdiction, is particularly useful as a consultation database by those contemplating a relocation to other jurisdictions, or perhaps for those doing business in various jurisdictions or have entered into some form of a contract or agreement in one or more jurisdictions.

User alerts are also contemplated by the invention to alert a user, such as by e-mail, to recent changes in a legal environment in a specific jurisdiction. An example of such an annotation alert is illustrated below:

### EXAMPLE 2

### Attention: user-please turn on e-mail alerts below which will notify you if there is a change in the law or a new article posted for your state or jurisdiction

### e-mail alerts ● on ◯ off

Washington State living Together law
XXXXXYYYUU provides the following summary of law important to unmarried couples. You may use the drop down menu to view summaries from other states.
Child adoption by partner Second parent adoption is permitted in some counties including King, Spokane and Thurston
Enforce ability Living together agreements are enforceable: Courts shall divide property of unmarried co-habitants in a just and equitable manner. Connell v. Francisco, 898 P.2d 831 (Wash. 1995); Vasquez v. Hawthorne, P.3d 735 (Wash 2001)
Law defining Marriage “(1) Marriage is a civil contract between a male and a female . . . ” Rev. Code. Wash. § 26.04.010
Parenting Former same-sex partner could seek visitation in court when she had parent-like relationship with child. Carvin v. Britain, 2004 Wash. App. LEXIS 833. Washington's liberal visitation statute was found unconstitutional when applied to grandparents seeking visitation over objections of a parent. Troxel v. Granville, 530 U.S. 57, 120 S.Ct. 2954 (2000)

### Display Headlines and Law for Washington

Headlines

Travel Insurance Covers Unmarried Couples
Apr. 26, 2005—According to news reports, Travel Guard Insurance Company offers travel insurance coverage to unmarried couples who can show they have been together for at least ten consecutive months. According to the company, most trip cancellations are due to illness or injury of a family member. If a trip were cancelled by an unmarried couple, they would be covered under one our polcies.

Spokane Approves benefits for Unmarried Couples
Washington—Apr. 25, 2005—The Spokane City Council has approved a controversial measure that would extend benefits to unmarried partners of city employees if their unions negotiate for those benefits.

Support Grows for Federal marriage Amendment
Apr. 19, 2005—Public support for an amendment to the U.S. Constitution defining marriage as being “between a man and a woman, thus barring marriages between gay or lesbian couples” has now risen to 57% in a recent Gallup poll, the highest since the summer of 2003. The poll, conducted Mar. 18-20, 2005 shows that 37% of Americans oppose such a constitutional amendment. Support for an amendment has ranged from 53% in February 2004 to a low point of 48% last July to the current 57%.

Federal marriage Amendment Returns
Mar. 17, 2005—Rep. Dan Lungren, R-Calif. Proposed the following as an amendment to the United States Constitution: “Marriage in the United States shall consist of only a legal union of a man and a woman. No court of the United States or of any State shall have jurisdiction to determine whether this Constitution or the Constitution of any State requires that the legal incidents of marriage be conferred upon any union other than a legal union between one man and one woman. No state shall be required to give effect to any public act, record or judicial proceeding of any other State concerning a union between persons of the same sex that is treated as a marriage, or as having legal incidents of marriage, under the laws of such other State.”

As will be appreciated, a user do-it-yourself database is thus provided by the invention with annotated services searchable as to legal implications in a state or other specific jurisdiction with respect to a particular document reflecting certain circumstances and facts 24 hours a day any day of the week, and searchable by anyone located in any geographic area with access to an Internet web site or e-mail.

In another preferred embodiment of the invention, a user-created, jurisdiction specific document may be automatically stored in a database for safe keeping and for easy locating and retrieval as desired or when the need arises. For example, when an alert informs a user as to a change in local law, rules or regulations, the user may sign in to the inventive service with, perhaps, a password or electronic signature, to make necessary changes to any of the user's existing and stored documents to reflect such changes as appropriate. This feature is particularly convenient while a person may be in transit or in a location where access to and consultation with traditional files is not possible. The database may be maintained on any server, remote or otherwise, and may store a plurality of user-created, jurisdiction specific documents, or several of the same type of document, but with each specific to the legalities in different jurisdictions for the creation of a personal document library complete with jurisdiction specific annotations, as described above, and headline archives. As one may imagine, such features also provide particular advantages in the educational arena, such as in a business or business law course of studies or in a law school or comparative law environment. It will also provide significant advantages to those whose lifestyle or employment duties routinely traverse several jurisdictions, such airline workers or other workers traveling internationally and encountering frequent legal environment changes.

In yet another aspect and embodiment of the present invention, it is further contemplated that the multi-jurisdictional e-commerce created document products of the invention, their method of production and a system encompassing such products and methods may be employed in conjunction with conducting one or more, or an array of business methods and functions, such as designing, manufacturing, marketing, selling, licensing, and leasing endeavors, or employed as subject matter for the production of valuable trade mark and tradedress rights, or perhaps as novel subject matter to be used in the formation of a business entity, such as a partnership, joint venture or corporation and the like. Other contemplated embodiments of this aspect of the invention include the partnering of business entities or of other persons and with offered discounts for member users of a partner entity for promotional purposes or advantages, such as, for instance, established bar associations, automobile associations and other trade groups and the like. Still other contemplated embodiments include an Internet web site accessible online message board or chat service encompassing the invention, for example, to promote or encourage discussion of relevant issues and perhaps changing laws, and also to provide a convenient venue for members to meet each other

It will be further appreciated by those persons skilled in the art that the embodiments described herein are merely exemplary of the principles of the invention. Such are merely intended to be illustrations and are not intended to be limiting of the scope or spirit of the invention or claims in any way, and many modifications and variations are possible without departing from the spirit and scope of the invention and claims.

We claim:

1. A method for a user to create legal related documents electronically, and wherein said documents are automatically created with language specific to a legal jurisdiction.

2. The method of claim 1 wherein said documents are automatically annotated as to changes in a specific legal jurisdiction

3. The method of claim 2 wherein said user-creator is electronically alerted as to said annotations.

4. The method of claim 1 in which the user is presented with a menu from which to choose a construct or a template of a contemplated document specifically tailored to a specific legal jurisdiction as to language reflecting local laws, rules and/or regulations, and in which said user is then prompted to answer a questionnaire with respect to said chosen document.

5. The method of claim 1 wherein said legal jurisdiction encompasses one or more of the several states, territories or possessions of the United States, one of the grouping of states within the jurisdiction of a United States circuit court of appeals, or that of a foreign country, state or territory, or international geographic areas.

6. The method of claim 1 wherein said documents may created by way of an Internet web site, a PDA, or a SMS, EMS and MMS enable wireless device.

7. The method of claim 1 wherein said fabricated document may be stored in a database.

8. A product document prepared by the method of claim 1.

9. A product document prepared by the method of claim 2.

10. A product document prepared by the method of claim 3.

11. A product document prepared by the method of claim 4.

12. A product document prepared by the method of claim 5.

13. A product document prepared by the method of claim 6.

14. A product document prepared by the method of claim 7.

15. A method of conducting business comprising the method of claim 1.
